(19) United States
(12) Patent Application Publication
(10) Pub. No.: US 2012/0042017 A1
(43) Pub. Date: Feb. 16, 2012

(54) Techniques for Reclassifying Email Based on Interests of a Computer System User

(75) Inventor: ERIC P. FRIED, AUSTIN, TX (US)

(73) Assignee: INTERNATIONAL BUSINESS MACHINES CORPORATION, Armonk, NY (US)

(21) Appl. No.: 12/854,258

(22) Filed: Aug. 11, 2010

(51) Int. Cl. G06F 15/16

(52) U.S. Cl. 709/206

(57) ABSTRACT

A technique for reclassifying email includes receiving, by an agent executing on a data processing system, a first input from an email filter. In this case, the first input provides a first indication of whether a received email is a junk email. The agent also receives a second input from an application. In this case, the second input provides a second indication of information of interest to a user of the data processing system. The agent then reclassifies the received email based on the first and second indications.

### BACKGROUND

This disclosure relates generally to reclassification and, more specifically, to reclassifying email based on interests of a computer system user.

Today, electronic mail (email) spam filters are usually configured to automatically file or delete spam or junk email. For example, trainable spam filters are known that perform document vector computations and automatically flag an incoming email message based on the incoming email message's n-spatial proximity to clusters of other email messages known to be spam. In general, known email filters either associate individual words with spam/not-spam probabilities and then calculate a sum of the whole document based on the probabilities of the words in the document, or index the document based on frequency (and possibly position) of individual words and perform vector math against other known spam documents. Typically, a word found in an email message is classified based on other email messages examined, but the word is not classified based on correlation factors between pairs or groups of words within the message. For example, a popular trick employed by spammers has been to utilize nonsense phrases with “good” words to throw-off a typical spam filter. Today, existing desktop solutions index files (on a computer system) that include text to facilitate file searches by a user of the computer system.

In general, a typical computer system user accumulates a relatively large amount of content (e.g., documents the user downloaded and created and emails the user received) on their computer system(s). In a typical case, managing content may be difficult and create various problems, e.g., a user may receive junk email that the user has to identify and remove from their computer system (or email server) in order to free-up storage space. Moreover, managing a location of documents on a computer system has generally involved saving related files in the same location for ease of management. However, when the number of locations where a file can be saved and the number of files is relatively large, duplicate documents may be created in different locations and documents that are not stored in a correct location may be difficult to find at a later point in time. To address these problems, a multi-input pluggable, extensible classification agent has been proposed to classify content arriving on a computer system of a user to form a corpus that facilitates comparison and allows applications and users to associate classification actions with content.

In general, the proposed agent would be configured to automatically handle various content such that, for example, junk email would be correctly deleted and files saved to a computer system would be placed in a desired directory without extensive user action. The proposed agent would utilize content (including content on remote computer systems) that a user viewed from a computer system of the user to form a corpus used to accurately classify new content for the user. The proposed agent would use the learned correlation between words in a document to determine accurate classification of new content. In this case, association data provided by applications could be utilized to determine what happens with content that meets certain classification criteria. For example, existing technologies (similar to some parental controls) could be employed to read all text that is displayed on a screen of the computer system of the user. In this example, read text (input1) included not only documents as the documents were being viewed, but also included content not directly associated with files on the computer system of the user (e.g., text viewed through a browser, a telnet session, and a remote desktop session). The proposed agent would also employ other existing technologies to gather data (input2) from all files stored locally on the computer system.

In general, the proposed agent (running on the computer system of the user) would: perform data gathering from input1 and input2; perform indexing and classification of the incoming data; listen to participating applications (i.e., applications from which the proposed agent received data) to gather action association data; and process action association look-up requests from participating applications. When the proposed agent received (from a requesting application) an action association request for a given document, the proposed agent would index the document to discover its classification identifier and use the identifier along with the identity of the requesting application to return the identifier of one or more associated actions. The application would then use the information to decide on an automatic or default suggested action for the disposition of the document. In other words, the proposed agent would provide a service to help applications decide what to do with data under certain circumstances. As one example, when a user composed a word processing document from scratch and chose to save the document, prior to displaying a file save dialog, a word processor would ask the proposed agent for actions associated with the document. In this example, assuming the agent provided a proposed default location to save the document, the user would be provided with the option of saving the document according to the classification identifier, creating a new classification identifier, or disregarding the document.

### SUMMARY

According to one aspect of the present disclosure, a technique for reclassifying email includes receiving, by an agent executing on a data processing system, a first input from an email filter. In this case, the first input provides a first indication of whether a received email is a junk email. The agent also receives a second input from an application. In this case, the second input provides a second indication of information of interest to a user of the data processing system. The agent then reclassifies the received email based on the first and second indications.

### BRIEF DESCRIPTION OF THE DRAWINGS

The present invention is illustrated by way of example and is not intended to be limited by the accompanying figures, in which like references indicate similar elements. Elements in the figures are illustrated for simplicity and clarity and have not necessarily been drawn to scale.

FIG. 1 is a block diagram of an example data processing environment that may be configured to reclassify email based on interests of a computer system user according to various aspects of the present disclosure.

FIG. 2 is a flowchart of an example process for reclassifying email based on interests of a computer system user according to various aspects of the present disclosure.

FIG. 3 is a view of a relevant portion of an example screen provided by an email application in which an email filter has directed two emails to a spam folder of a computer system user.

FIG. 4 is a view of a relevant portion of an example screen provided by the email application of FIG. 3 in which an agent, configured according to the present disclosure, has caused one of the emails of FIG. 3 to remain in (or be redirected to) an inbox folder of the computer system user based on interests of the computer system user.

FIG. 5 is a view of a relevant portion of an example screen provided by the email application of FIG. 3 in which an agent, configured according to the present disclosure, has caused one of the emails of FIG. 3 to be redirected to (or remain in) the spam folder of the computer system user based on interests of the computer system user.

FIG. 6 is a view of a relevant portion of an example screen provided by an email application in which an email filter has directed two emails to an inbox folder of a computer system user.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. As may be used herein, the term “coupled” includes both a direct electrical connection between blocks or components and an indirect electrical connection between blocks or components achieved using one or more intervening blocks or components.

According to various aspects of the present disclosure, techniques for reclassifying email include receiving, by an agent executing on a data processing system (i.e., a user computer system or user client), a first input from an email filter. The first input may be provided directly from the email filter to the agent or may be provided indirectly from the email filter to the agent. For example, the email filter may cause an email application to store an incoming email to a particular directory of a storage device and the agent may examine files on the storage device to determine if the files are stored in a correct directory based on interests of the computer system user. In any case, the first input provides a first indication of whether a received email is a junk email, e.g., by the folder (e.g., a spam folder or an inbox folder associated with an implemented email application) in which the received email is stored. The agent also receives a second input from an application. In this case, the second input provides a second indication of information of interest to a user of the data processing system.

The application may correspond to a browser, a word processing application, a notepad application, or any application that is capable of providing information that an agent can utilize to determine interests of the computer system user. The agent then reclassifies (e.g., with or without concurrence from the computer system user) the received email based on the first and second indications. For example, assuming that a computer system user recently authored a word processing document on Canadian drugs and/or extensively browsed a web page advertising Canadian drugs, an agent may (based on input received from an associated browser and/or word processing application) redirect emails whose subject matter includes Canadian drugs (and was directed to a spam folder by the email filter) to an inbox folder associated with an email application of the computer system user. An agent may employ various technologies in determining whether information is of interest to a computer system user. For example, the agent may examine a web page of interest to a computer system user by performing a screen dump and utilizing optical character recognition (OCR) to determine the subject matter of the screen dump (commonly referred to as screen scraping). As another example, the agent may examine a web page of interest to a computer system user by performing a text search of hypertext markup language (HTML) code associated with the web page.

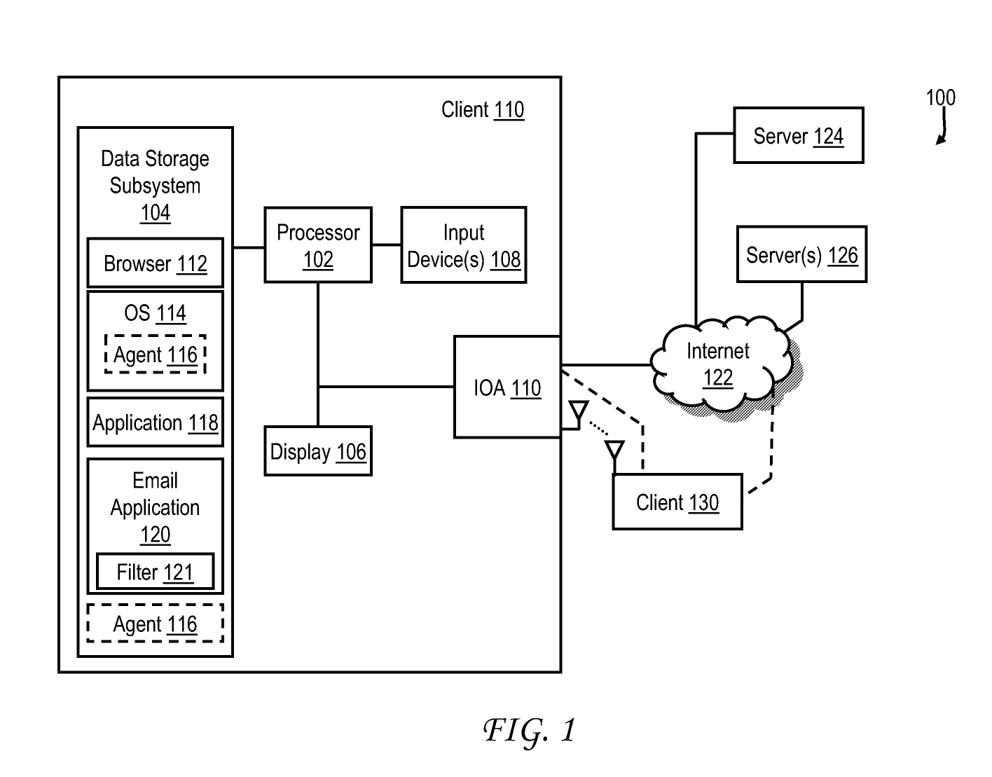

With reference to FIG. 1, an example data processing environment 100 is illustrated that includes a client 110 and a client 130 that are configured to reclassify emails based on interests of an associated computer system user. Clients 110 and 130 may take various forms, such as workstations, laptop computer systems, notebook computer systems, smart phones, web-enabled portable devices, or desktop computer systems. For example, client 110 may correspond to a desktop computer system of a computer system user and client 130 may correspond to a web-enabled device of the computer system user. In this case, it may be desirable for clients 110 and 130 to periodically synchronize reclassification data, such that emails received on both clients 110 and 130 are reclassified according to current interests of the computer system user.

Client 110 includes a processor 102 (which may include one or more processor cores for executing program code) coupled to a data storage subsystem 104, a display 106, one or more input devices 108, and an input/output adapter (IOA) 109. Data storage subsystem 104 may include, for example, an application appropriate amount of volatile memory (e.g., dynamic random access memory (DRAM)), non-volatile memory (e.g., read-only memory (ROM) or static RAM), and/or non-volatile mass storage device, such as a magnetic or optical disk drive. Data storage subsystem 104 includes an operating system (OS) 114 for client 110, as well as application programs, such as a browser 112 (which may optionally include customized plug-ins to support various client applications), email application 120 (which includes an email filter 121), and an agent 116 that may optionally be included within the OS 114 or be employed as a separate application that has visibility into OS 114 functionality. For example, agent 116 may monitor an application information stream or examine a hard disk drive (commonly referred to as disk trawling) or other storage device associated with a computer system to determine interests of a computer system user.

As is well known, a browser (or web browser) is a software application that allows a user (at a client) to display and interact with text, images, and other information located on a web page at a website (hosted by an application server) on the World Wide Web or a local area network. Text and images on a web page may contain hyperlinks to other web pages at the same or different website. Browsers allow a user to quickly and easily access information provided on web pages at various websites by traversing hyperlinks. A number of different browsers, e.g., Internet Explorer™, Mozilla Firefox™, Safari™, Opera™, and Netscape™ are currently available for personal computers. In general, browsers are the most commonly used type of hypertext transfer protocol (HTTP) user agent. While browsers are typically used to access web application servers (hereinafter “web servers”) that are part of the World Wide Web, browsers can also be used to access information provided by web servers in private networks or content in file systems.

Display 106 may be, for example, a cathode ray tube (CRT) or a liquid crystal display (LCD). Input device(s) 108 of client 110 may include, for example, a mouse, a keyboard, haptic devices, and/or a touch screen. IOA 109 supports communication of client 110 with one or more wired and/or wireless networks utilizing one or more communication protocols, such as 802.x, HTTP, simple mail transfer protocol (SMTP), etc. IOA 109 also facilitates synchronization between clients 110 and 130 to provide a wider base of reclassification information to agents executing on client 110 and 130. Due to the wider base of available information, agents executing on clients 110 and 130 can generally make better reclassification decisions on respective received emails.

Clients 110 and 130 are coupled via one or more wired or wireless networks, such as the Internet 112, to an email server 124 and various web page servers 126 that provide information of interest to the user of clients 110 and 130. For example, servers 126 execute on or more applications to serve web pages accessed by browsers 112 and receive inputs from the browser 112 to provide information of interest to the user of client 110. In a typical embodiment, the user of client 110 employs browser 112 to interact with and manipulate various web pages provided by respective applications executing on servers 126. While only two clients are shown associated with a single computer system user, it should be appreciated that one or more clients may be associated with a single computer system user.

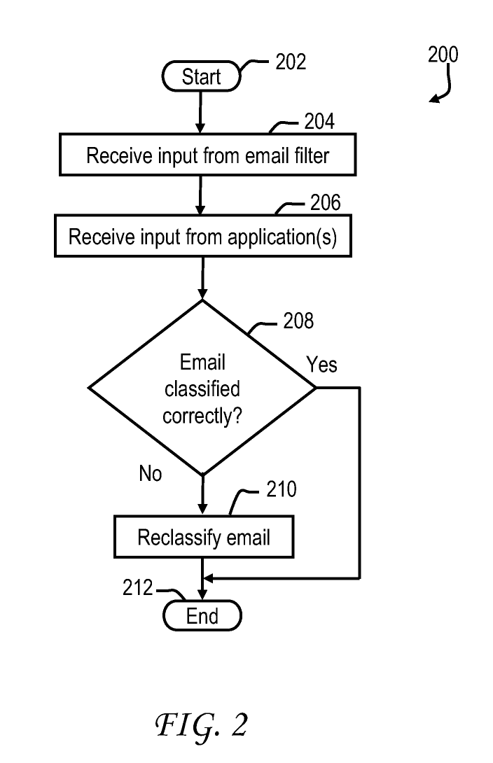

With reference to FIG. 2, an example process 200 is illustrated that reclassifies emails based on interests of a computer system user according to various aspects of the present disclosure. It should be appreciated that process 200 may execute, at any given point in time, on client 110 or client 130 and that any number of clients may be associated with a single computer system user. Process 200 is initiated at block 202 by agent 116, which may be included as part of OS 114 or may be a stand-alone application that has visibility into OS 114 functionality. Process 200 then proceeds to block 204, which depicts agent 116 receiving input from email filter 121, which is included as part of email application 120. As noted above, the input received from email filter 121 may simply correspond to a location on an HDD where email filter 121 has caused a received email to be stored.

Next, in block 206, agent 116 receives input from an application (e.g., browser 112 and/or application 118). For example, agent 116 may initiate a screen dump from display 106 to gather information that is of interest to the computer system user. In this case, agent 116 may initiate optical character recognition (OCR) on the screen dump to provide text that can be analyzed for keywords to determine interests of the computer system user. The screen dump may correspond to a web page provided by one of servers 126 or may correspond to an image or object included in a file associated with application 118. Alternatively, agent 116 may examine a recently opened document (e.g., a word processing document) for keywords to determine interests of the computer system user. Then, in decision block 208, agent 116 determines whether an email (received by client 110 or client 130) has been classified correctly by email filter 121 of email application 120. For example, agent 116 may examine files stored on an hard disk drive (HDD) of data storage subsystem 104 to determine if the stored files have been stored in a correct folder (i.e., an inbox folder or a spam folder). Agent 116 may, for example, search the stored files for keywords of interest to the computer system user in making a determination of whether the stored files are in a correct folder on the HDD.

When an email is classified correctly in block 208, control transfers to block 212 where process 200 terminates and control returns to a calling routing. When an email is not classified correctly in block 208, control transfers to block 210 where agent 116 causes an incorrectly classified email to be reclassified. For example, if the input received from email filter 121 and the input received from application 118 (which indicates interests of the computer system user) do not coincide, agent 116 initiates reclassification of a received email by, for example, causing the email to be moved to an appropriate folder. Following block 210, control transfers to block 212, where process 200 terminates and control returns to a calling routine.

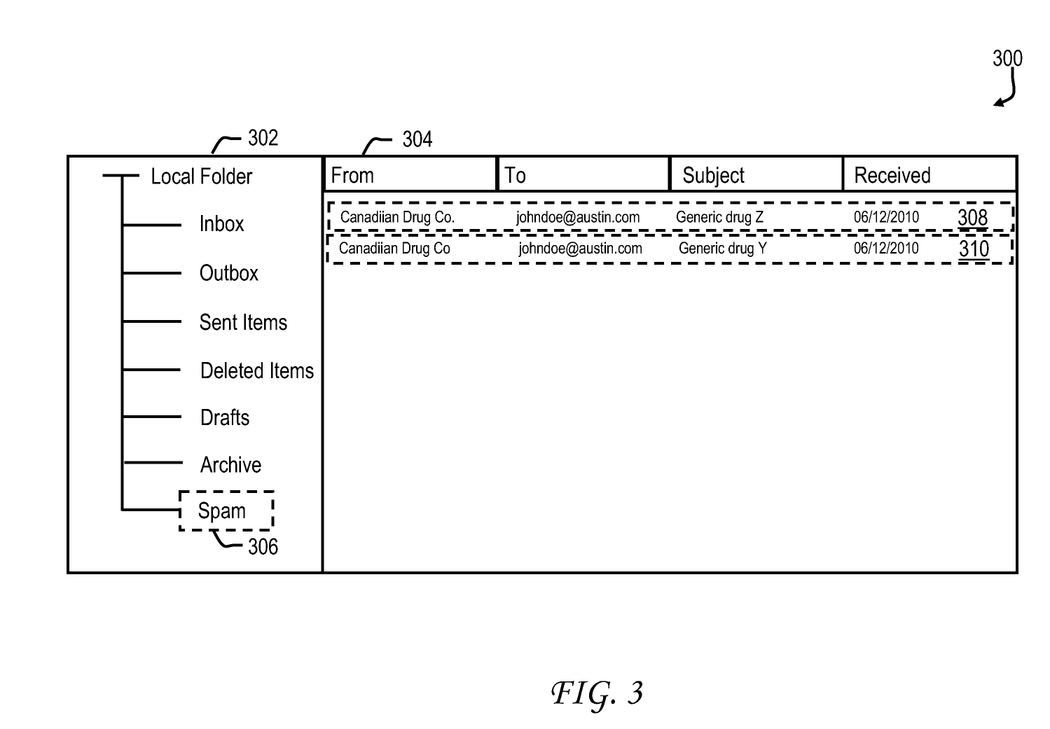

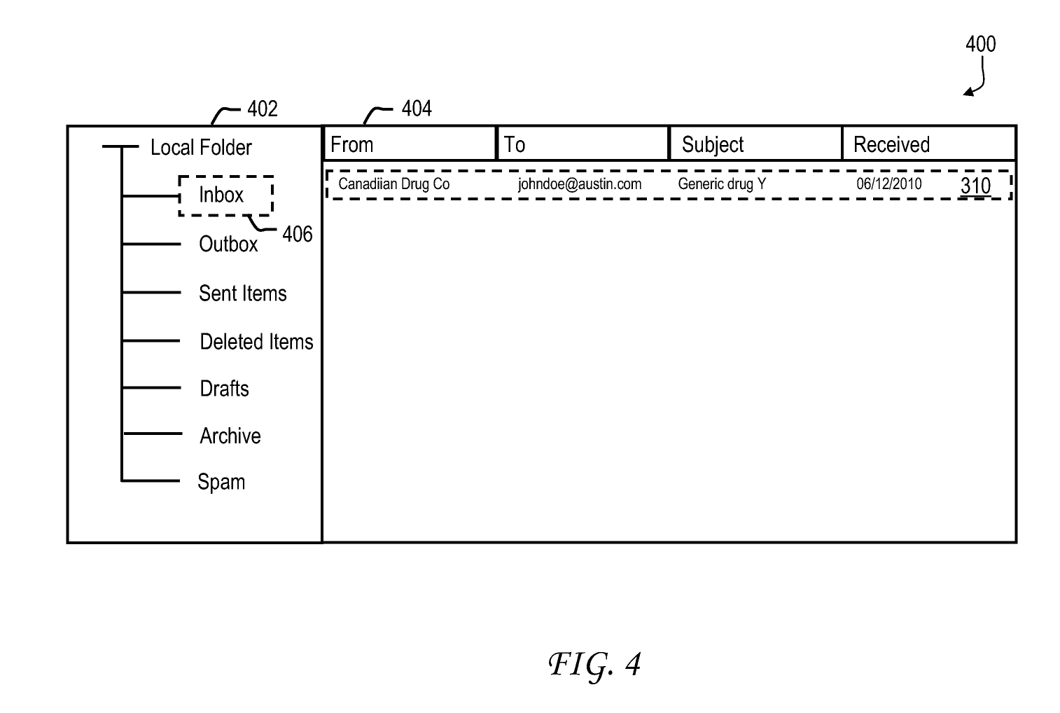

With reference to FIG. 3, a relevant portion of an example email screen 300 of a computer system user is illustrated that includes a folder tree portion 302 with a spam folder 306 selected and a message portion 304 that includes information on emails 308 and 310. As is illustrated, email 308 is from the Canadian Drug Company and is directed to the generic drug Z and email 310 is also from the Canadian Drug Company and is directed to the generic drug Y. In this example, both emails 308 and 310 were received by client 110 or 130 of the computer system user (John Doe) and were saved in spam folder 306 (by email filter 121) due to the respective content of emails 308 and 310. With reference to FIG. 4, a relevant portion of an example email screen 400 is illustrated that includes a folder tree portion 402 with an inbox folder 406 selected and a message portion 404 that includes information on email 310, which has been reclassified (by agent 116) as an email in which the computer system user has an interest based on input from an application. For example, the application may correspond to browser 112 and the input provided by browser 112 may correspond to information about a screen dump of a web page that included information on generic drug Y that was manufactured by the Canadian Drug Company and displayed to the computer system user using client 110 or client 130.

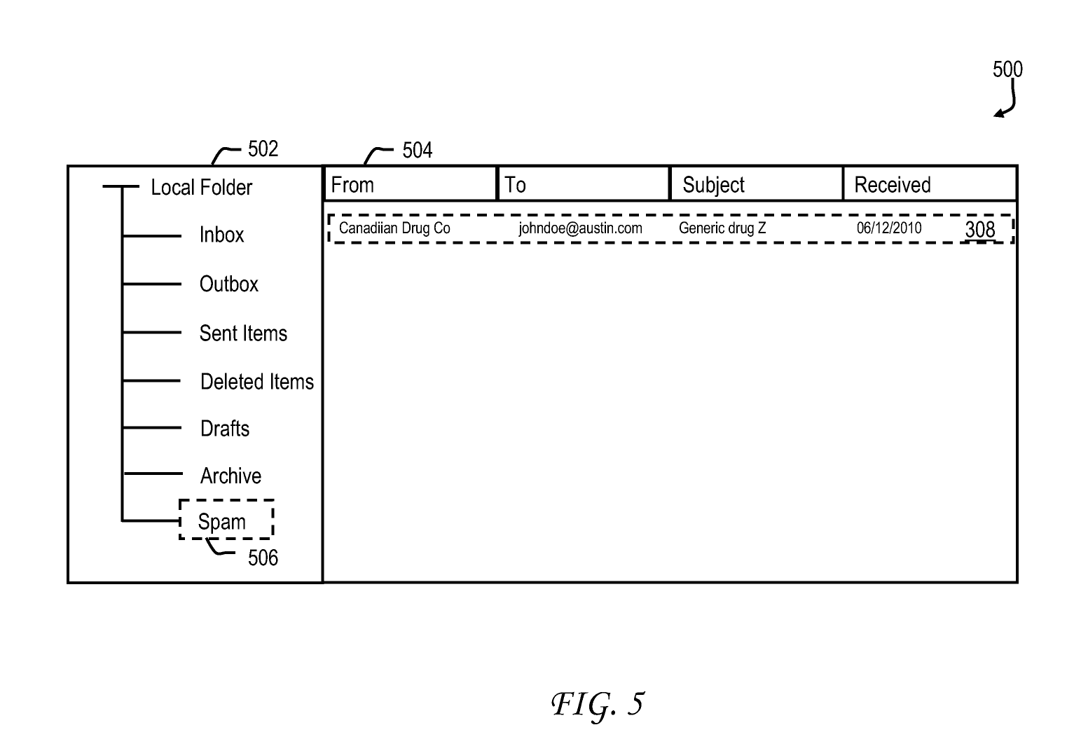

With reference to FIG. 5, a relevant portion of an example email screen 500 is illustrated that includes a folder tree portion 502 with a selected spam folder 506 and a message portion 504 that includes information on email 308, whose classification has not been changed (by agent 116) based on input from an application. For example, the input from the application may correspond to one or more of a web page, a song, a streamed video, a digital versatile disk (DVD) video, or a text document provided by a respective application executing on client 110 or client 130. That is, agent 116 has determined that email 308 is of no interest to the computer system user based on information received and has maintained email 308 (which is directed to generic drug Z manufactured by the Canadian Drug Company) in the spam folder of the email application, irrespective of the fact that the generic drug Z is a drug manufactured by the Canadian Drug Company. In this case, input provided to the agent 116 by the application provided no indication that the computer system user had an interest in generic drug Z.

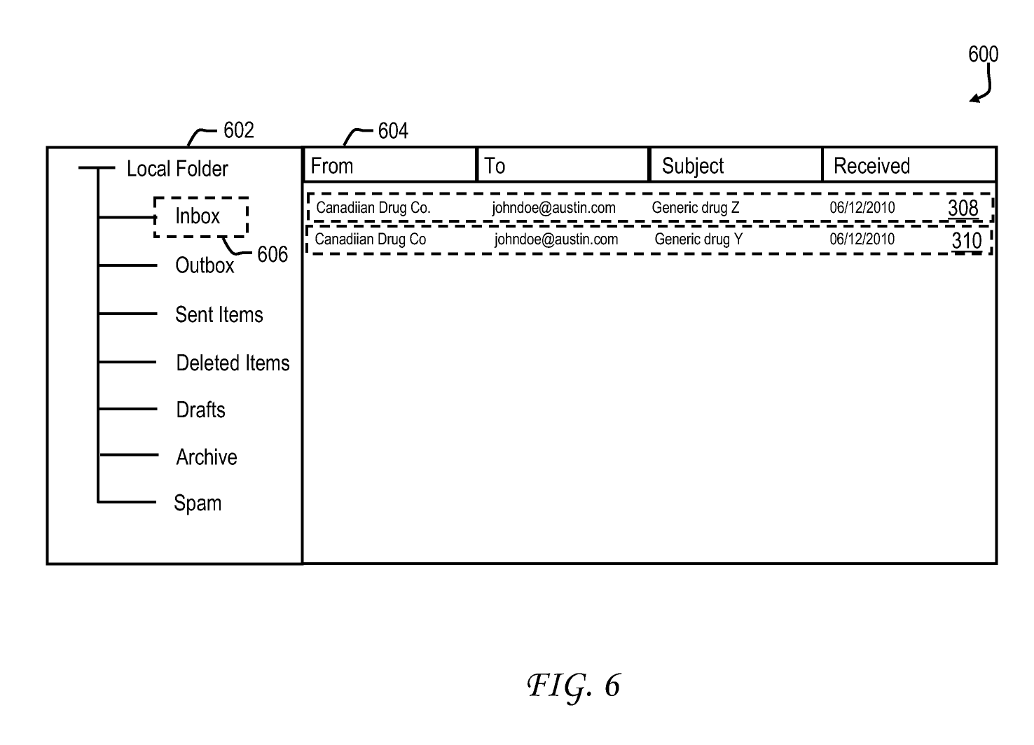

With reference to FIG. 6, a relevant portion of an example email screen 600 is illustrated that includes a folder tree portion 602 with a selected inbox folder 606 and a message portion 604. In this example, email filter 121 has incorrectly classified both emails 308 and 310 as being of interest to the computer system user. In this case, agent 116 may reclassify email 308 by causing email 308 to be moved to spam folder 506 (see FIG. 5) and allowing email 310 to remain in inbox folder 406 (see FIG. 4) according to input received (by agent 116) from email filter 121 and one or more applications. Alternatively, FIG. 6 may represent the case where agent 116 has caused both emails 308 and 310 to be redirected from spam folder 306 (see FIG. 3) to inbox folder 606 based on input (e.g., that the computer system user is interested in any drug manufactured by the Canadian Drug Company) received by agent 116 from one or more applications.

Accordingly, a number of techniques have been disclosed herein that reclassify emails based on interests of a computer system user.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of reclassifying email, comprising:
receiving, by an agent executing on a data processing system, a first input from an email filter, wherein the first input provides a first indication of whether a received email is a junk email;
receiving, by the agent executing on the data processing system, a second input from an application, wherein the second input provides a second indication of information of interest to a user of the data processing system; and
reclassifying, using the agent executing on the data processing system, the received email based on the first and second indications.

2. The method of claim 1, wherein the received email is reclassified from a junk email to a non junk email.

3. The method of claim 1, wherein the received email is reclassified from a non-junk email to a junk email.

4. The method of claim 1, wherein the agent is an operating system agent.

5. The method of claim 1, wherein the agent is an application.

6. The method of claim 1, wherein the second input corresponds to a song, a streamed video, a digital versatile disk (DVD) video, or a text document.

7. The method of claim 1, wherein an information stream associated with the application is monitored by the agent.

8. The method of claim 1, wherein the application is a word processor application or a web browser application.

9. A data processing system that reclassifies email, comprising:
a data storage subsystem; and
a processor coupled to the data storage subsystem, wherein the processor is configured to execute an agent that:
receives a first input from an email filter, wherein the first input provides a first indication of whether a received email is a junk email;
receives a second input from an application, wherein the second input provides a second indication of information of interest to a user of the data processing system; and
reclassifies the received email based on the first and second indications.

10. The data processing system of claim 9, wherein the received email is reclassified from a junk email to a non junk email.

11. The data processing system of claim 9, wherein the received email is reclassified from a non junk email to a junk email.

12. The data processing system of claim 9, wherein the agent is an operating system agent.

13. The data processing system of claim 9, wherein the agent is an application.

14. The data processing system of claim 9, wherein the second input corresponds to a song, a streamed video, a digital versatile disk (DVD) video, or a text document.

15. The data processing system of claim 9, wherein an information stream associated with the application is monitored by the agent.

16. The data processing system of claim 9, wherein the application is a word processor application or a web browser application.

17. A computer program product for reclassifying email, the computer program product comprising:
a computer readable storage medium having computer readable program code embodied therewith, wherein the computer readable program code, when executed by a data processing system, causes the data processing system to:
receive a first input from an email filter, wherein the first input provides a first indication of whether a received email is a junk email;
receive a second input from an application, wherein the second input provides a second indication of information of interest to a user of the data processing system; and
reclassify the received email based on the first and second indications.

18. The computer program product of claim 17, wherein the received email is reclassified from a junk email to a non-junk email or from a non junk email to a junk email.

19. The computer program product of claim 17, wherein an information stream from the application is monitored by the agent and the application is a word processor application or a web browser application

20. The computer program product of claim 17, wherein the second input corresponds to a song, a streamed video, a digital versatile disk (DVD) video, or a text document
